(19) United States
(12) Patent Application Publication
(10) Pub. No.: US 2012/0253847 A1
(43) Pub. Date: Oct. 4, 2012

(54) HEALTH INFORMATION TELECOMMUNICATIONS SYSTEM AND METHOD

(75) Inventors: Michael Joseph Dell'Anno, Clifton Park, NY (US); Michael James Hartman, Clifton Park, NY (US); Robert James Mitchell, JR., Waterford, NY (US); John Anderson Fergus Ross, Niskayuna, NY (US); Stanislava Soro, Niskayuna, NY (US); John Erik Hershey, Ballston Lake, NY (US)

(73) Assignee: GENERAL ELECTRIC COMPANY, SCHENECTADY, NY (US)

(21) Appl. No.: 13/076,962

(22) Filed: Mar. 31, 2011

(51) Int. Cl. G06Q 50/00; G06Q 10/00

(52) U.S. Cl. 705/3; 705/2

(57) ABSTRACT

Health information communications systems and methods are disclosed. In one embodiment, the system includes one or more medical sensors providing one or more health information data types. The system further includes a patient communications device coupled to at least one medical sensor over a communications network. Particularly, the patient communications device includes a patient quality of service (QoS) manager that dynamically specifies a set of data quality management parameters for transporting at least some of the health information and modifies at least some of the health information into value factored health information. Additionally, the system includes a specialist communications device communicatively coupled to the patient communication device over the communications network. The specialist communications device includes a specialist QoS manager that provides measured channel characteristics to the patient communications device. The patient QoS manager dynamically specifies the set of data quality management parameters based at least in part on the measured channel characteristics of the specialist communications device.

### BACKGROUND

Embodiments of the present system and technique relate generally to communications, and more particularly to systems and methods for health information telecommunication.

Evolution of telecommunications technology has made communications pervasive across the globe. Accordingly, electronic health systems have also quickly evolved from traditional desktop systems to wireless, mobile and wired systems incorporating high bandwidth configurations. The application of telecommunication networks to a medical environment provides, for example, a unique opportunity to shift specialized healthcare outside a traditional hospital setting to a patient in a clinic, home-centered and/or mobile unit setting. Particularly, telemedicine systems enable provision of specialized medical services over large geographical areas, including rural areas, where modern medical facilities and skilled medical practitioners are either centralized or have limited reach. These telemedicine systems, thus, facilitate access to medical resources, earlier detection of medical conditions and expeditious provision of medical services in emergency situations.

To that end, certain present day telemedicine systems include sensors that acquire health information such as heart rate, oxygen saturation levels and electrocardiogram (EKG) data. The acquired health information is then transmitted to receiving devices such as laptops or personal digital assistants (PDAs), which can display the acquired health information in real time. Certain other systems include wireless sensor networks that integrate heterogeneous devices including wearable sensors and static environmental sensors. Another telemedicine solution proposes an integration of sensing, computing, wireless networking and middleware technologies to build an assisted living environment for elderly people.

Although existing day telemedicine systems have made significant efforts for providing quality medical services, there remains a gap between the availability of these systems and their practical implementation. Many of the telemedicine systems, for example, rely on proprietary hardware and/or dedicated or specialized wireless links such as ISDN or satellite links for transmitting patient information. These dedicated links are costly and typically provide only marginal performance and reliability. Commercial wireless links such as cellular are highly unreliable due to low data rates, congestion, and repeated interruption, thus limiting their use in emergency medicine. Particularly, the large volume and data size of health information render even systems with adequate bandwidth insufficient for reliable transmission of the high priority health information as and when desired by a medical specialist. The telemedicine systems, therefore, often fail to ensure timely and robust delivery of life-critical medical data in unreliable and resource-constrained networking environment.

It is desirable to develop systems and methods for securely and efficiently communicating health information with customized QoS in different scenarios without requiring expensive equipment or proprietary network resources. Particularly, there is a need for a system that allows different medical devices to interoperate by enabling easy integration, switching, upgrade, and configuration of the different medical devices. It may further be desirable to develop a system that facilitates storing and managing health and diagnostics information for complying with insurance, legal requirements, billing and enabling subsequent analysis to improve the quality of remote patient care.

### BRIEF DESCRIPTION

In accordance with aspects of the present system, a health information communications system is disclosed. To that end, the system includes one or more medical sensors that provide one or more data types of health information. The system further includes a patient communications device communicatively coupled to a communications network and to at least one of the medical sensors. Particularly, the patient communications device includes a patient quality of service (QoS) manager that dynamically specifies a set of data quality management parameters for transporting at least some of the health information and modifies at least some of the health information into value factored health information. Further, the system also includes a specialist communications device communicatively coupled to the patient communication device over the communications network. The specialist communications device includes a specialist quality of service (QoS) manager configured to provide measured channel characteristics to the patient communications device. The patient QoS manager dynamically specifies the set of data quality management parameters based at least in part on the measured channel characteristics of the specialist communications device.

In accordance with another aspect of the present technique, a method for communicating health information is described. The method includes measuring one or more channel characteristics between a patient communications device and a specialist communications device, where the channel characteristics correspond to one or more communication channels in the communications network. Further, medical information is transmitted from one or more sensors communicatively coupled to the patient communications device. To that end, a set of quality of service (QoS) parameters are dynamically specified for at least some of the medical information based in part on the channel characteristics. Particularly, at least some of the medical information is processed into value factored medical information based on the set of quality of service (QoS) parameters. At least some of the value factored medical information is transported from the patient communications device over the communication channels. Further, at least some of the value factored medical information at the specialist unit over the communications channel.

In accordance with a further aspect of the present system, a health information communications unit is presented. The health information communications unit includes a processing unit and a memory section coupled to the processing unit. The health information communications unit also includes one or more medical sensors communicatively coupled to the processing unit, the medical sensors providing health information of one or more data types. Further, the health information communications unit includes a patient quality of service (QoS) manager operating on the processing unit. The patient QoS manager is configured to process at least some of the health information as value factored health information and transport at least some of said value factored health information over a communications network. To that end, the patient QoS manager configures at least some of the value factored health information for said transport based on measured channel characteristics of the communications network. Additionally, the health information communications unit includes a specialist QoS manager interfacing with the patient QoS manager over the communications network, the specialist unit configured to receive and process at least some of the value factored health information.

### DRAWINGS

These and other features, aspects, and advantages of the present technique will become better understood when the following detailed description is read with reference to the accompanying drawings in which like characters represent like parts throughout the drawings, wherein:

FIG. 1 is a block diagram of an exemplary health information communications system, in accordance with aspects of the present system;

FIG. 2 is a block diagram illustrating an exemplary patient unit of the system illustrated in FIG. 1;

FIG. 3 is a block diagram illustrating an exemplary specialist unit of the system illustrated in FIG. 1;

FIG. 4 is a schematic representation of an exemplary control, monitoring, and data flow between various components of the system illustrated in FIG. 1;

FIG. 5 is a block diagram illustrating an exemplary data quality manager of the system illustrated in FIG. 4;

FIG. 6 is a flow chart depicting an exemplary operation of the reliability decisioner of the system illustrated in FIG. 4;

FIG. 7 is a flow chart depicting an exemplary operation of the data quality decisioner of the system illustrated in FIG. 4;

FIG. 8 is a flow chart depicting an exemplary operation of the compression manager of the system illustrated in FIG. 4;

FIG. 9 is a flow chart depicting an exemplary method for communicating health information; and

FIG. 10 is a schematic representation of an exemplary display of the specialist unit illustrated in FIG. 3.

### DETAILED DESCRIPTION

The following description presents systems and methods for communicating health information in a predictable and reliable manner. Conventional telemedicine systems fail to provide customized quality-of-service (QoS) required for effectively communicating different kinds of medical data. Accordingly, large image files with no urgency can occupy a majority of the infrastructure bandwidth to the detriment of emergency telemedicine requirements. Additionally, the proprietary nature of these telemedicine systems makes it difficult for an end-user to easily and efficiently expand and/or customize the system processing. Conventional telemedicine systems, thus, fail to provide the QoS in different situations reliably and securely without incurring excessive networking and computational costs.

Accordingly, embodiments illustrated hereinafter describe methods and systems for health information telecommunications for communicating different kinds of health information with a specified QoS through one or more types of communications networks. By way of example, the different kinds of health information include EKG data, oxygen saturation levels, ultrasound data, audio data, video data, or any other suitable health information. Furthermore, the present system enables easy integration, switching, upgrade, configuration, and operation of the different medical devices, thereby reducing system setup time. Additionally, the present system facilitates its own diagnostics and prognostics to ensure reliable and safe operation for prolonged periods.

Although the following description includes only a few embodiments, the present system may be implemented in many different operating environments and systems for communicating health information. By way of example, the present system may be used in an edge medical device, medical specialist's workstation, a mobile device, a router and/or a hospital server that can be communicatively coupled to the one or more types of communications networks.

Particularly, in one embodiment, the present system is implemented in an edge medical device for intelligently communicating health information. Typically, domains at the edges of a network, such as the Internet, have more congestion as compared to the network core. Implementation of the present system in an edge device, therefore, facilitates prioritization of real-time and mission-critical data packets at the network edge using dynamically varying QoS parameters. As used herein, the term “dynamic” refers to a near real time control of data flow and reliability to enable optimum QoS. In one exemplary implementation, a patient QoS manager dynamically specifies a set of patient QoS parameters for routing the health information to a medical specialist intelligently based on the corresponding data type, prevailing network characteristics and the urgency of the situation. By way of example, in situations that use cellular networks for communicating health information during high cellular usage when the bandwidth is constrained, the system dynamically alters the data content and quality characteristics of the health information to suit the available bandwidth. In certain embodiments, the system may further allow a user or operator to specify certain input to modify the data content and quality characteristics based on a specified set of medical needs.

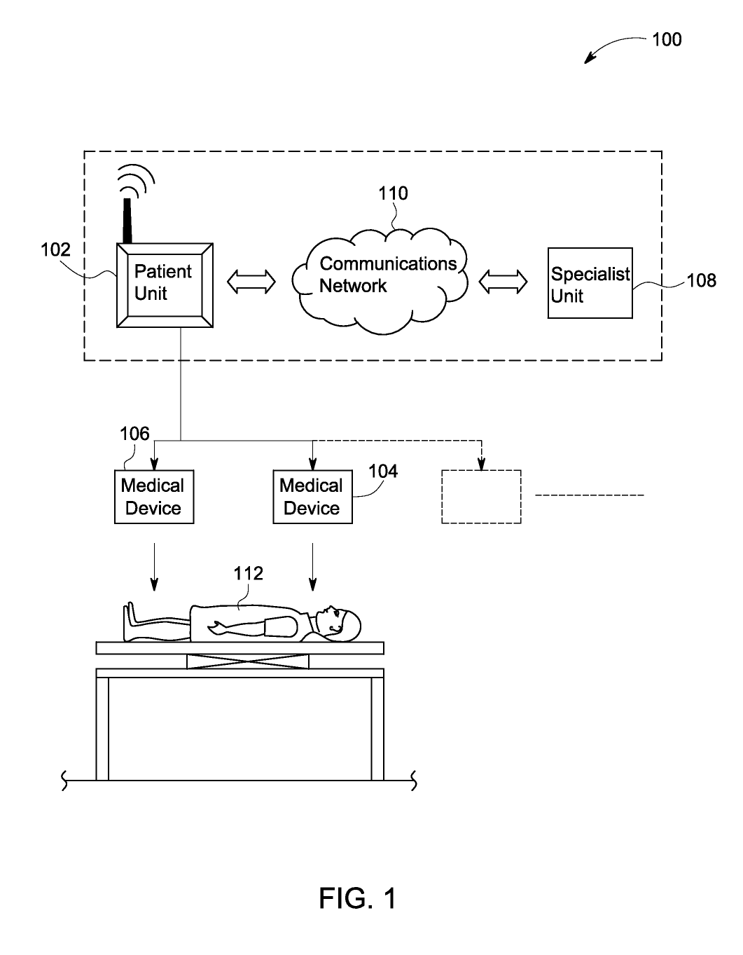

Accordingly, the present system may be implemented simultaneously in multiple edge medical devices as well as multiple specialists' workstations to facilitate intelligent and multi-directional communication. An exemplary environment that is suitable for practicing various implementations of the present system will be discussed in greater detail in the following sections with reference to FIG. 1.

FIG. 1 illustrates an exemplary health information telecommunications system 100 that intelligently communicates diverse classes of health information to and from a plurality of medical/health monitoring and diagnostics devices (medical devices). To that end, the system 100 may be implemented in a medical device, a mobile computing system, a desktop computer, a router and/or a communications server coupled to one or more communications networks. In addition, the system 100 provides for diverse applicability of health monitoring including, for example, but not limited to, monitoring in a home, an emergency site, a health practitioner's office, a military field site, a school, a nursing home, a retirement facility as well as a health facility.

Accordingly, in one embodiment, the system 100 includes a patient unit 102 that is communicatively coupled or integrated with one or more medical devices 104, 106 through a wired or wireless connection, the patient unit 102 providing for communicating with one or more specialist units 108. As used herein, the term “patient” may be broadly interpreted to include any living person or animal while the term “specialist” refers to a paramedic, a general physician, an expert medical practitioner, or any person suited to provide medical consultation. Accordingly, at least one embodiment of the system 100 is disposed at a patient's end (patient unit 102) and at least another disposed at a medical specialist's end (specialist unit 108) for communicating health information to and from the plurality of medical devices 104, 106.

To that end, the medical devices 104, 106 include such devices as an EKG device, a blood glucose monitor, a blood pressure monitor, an oxygen monitor, as well as more complex equipment such as a magnetic resonance imaging (MRI) system, a computed tomography (CT) system, an ultrasound system, an X-ray machine, an intravenous monitor, and/or an anesthesia monitor. As used herein, the term “medical devices”, however, is not limited to specific medical equipment but includes the peripheral devices used for medical purposes and further including video device, audio device, communications system, as well as other device communicatively coupled to the system 100 over one or more communications networks 110.

Although, the embodiment illustrated in FIG. 1 depicts only a single patient unit 102 and a single specialist unit 108, in alternative embodiments, the system 100 may include multiple patient units communicatively coupled or embedded with various medical devices 104, 106. These medical devices 104, 106 are then further coupled to a patient 112 for communicating information relevant to a medical examination being undertaken such as EKG, blood glucose level and/or blood pressure. Particularly, the system 100 allows for communication of health information to one or more specialist units 108 connected over the communication network 110 to the one or more patient units 102.

Particularly, in one embodiment, the system 100 provides universal health information by allowing access between multiple medical devices such as the medical devices 104, 106 coupled to the patient 112 and a facility or location where the medical data is processed. Accordingly, in one embodiment, the patient unit 102 may be co-located in a hospital or a health facility along with the specialist unit 108. In an alternative embodiment, however, the patient unit 102 may be located at another location such as a home, a health facility or a hospital and communicate the medical data received from multiple medical devices 104, 106 to multiple specialist units, including the specialist unit 108 over the communications network 110.

To that end, the communications network 110 may include wireless local area networks (WLAN), wide area networks (WAN) such as Worldwide Interoperability for Microwave Access (WiMax) networks, satellite networks, cellular networks, sensor networks, ad hoc networks and/or short-range networks. In alternate embodiments, the communication network 110 can be wired networks or a hybrid wireless and wired networks. The ability of the system 100 to connect to different communications network 110 ensures reliable communication of the health information between the patient unit 102 and the specialist unit 108 according to network conditions, user preferences and/or application requirements.

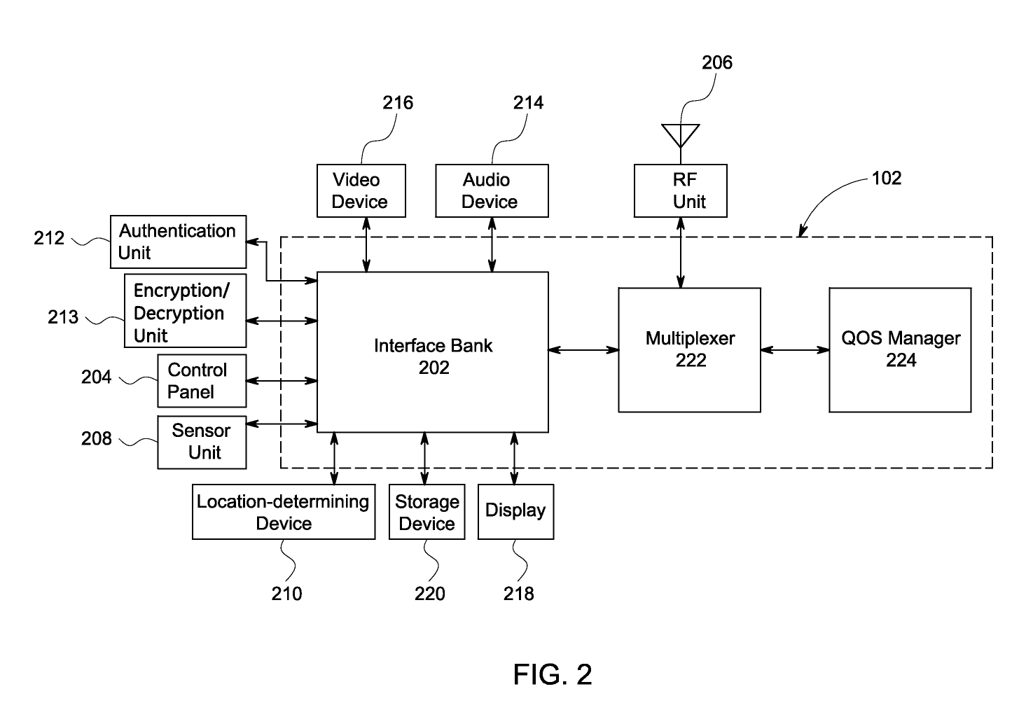

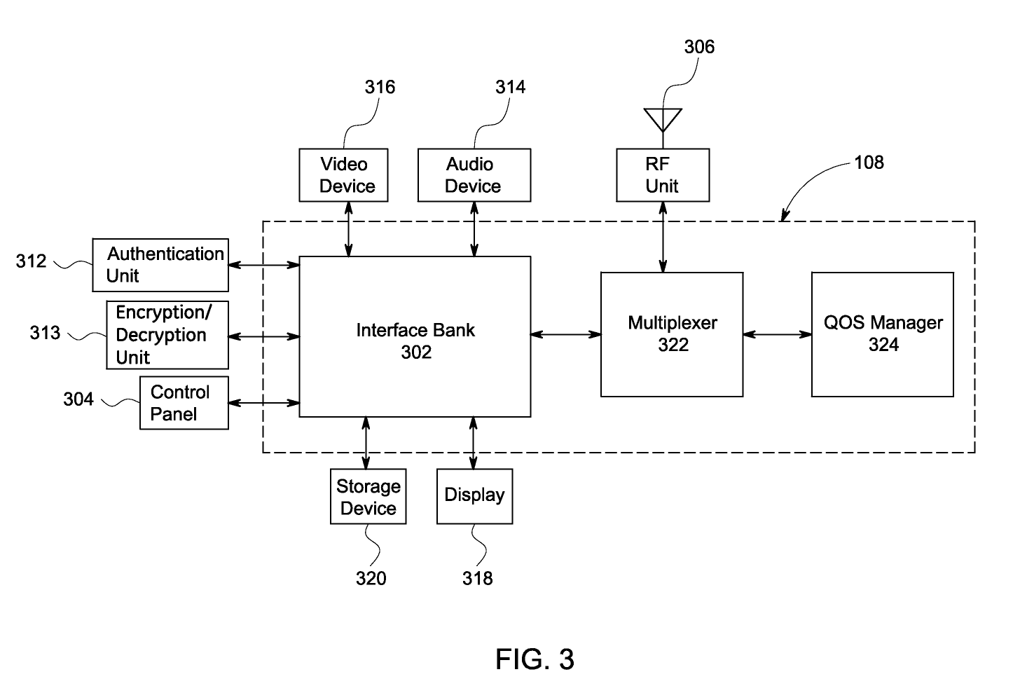

Accordingly, in one exemplary implementation, the communications network 110 refers to multiple types of communications networks that are available to the system to provide communications between the patient unit 102 and specialist unit 108. Such a configuration allows for switching between communications networks to support the communications exchange. For example, the communications network can be a wireless such as WLAN and if there is interference or other disruption to the communication flow, the system can evaluate the communication network options and select the best alternative. An exemplary configuration of the patient unit 102 and the specialist unit 108 for enabling adaptive communication of health information over the communications network 110 will be discussed in greater detail with reference to FIGS. 2-3.

FIG. 2 illustrates a schematic block diagram depicting an exemplary configuration of the patient unit 102 of FIG. 1. In one embodiment, the patient unit 102 includes an interface bank 202 that includes a plurality of interfaces that communicatively couple the patient unit 102 to one or more devices required for remote health monitoring and diagnostics. By way of example, the one or more devices include a control panel 204, a radio frequency (RF), wireless and/or wired communication unit 206 and/or a sensor unit 208 communicatively coupled to one or more medical devices (not shown).

In one embodiment, the sensor unit 208 includes one or more local medical devices or a processing unit communicatively coupled to the local medical devices. In one embodiment, the local medical devices include devices such as a magnetic resonance imaging (MRI) system, a computed tomography (CT) system, an ultrasound system, an EKG machine, a blood pressure monitor, an X-ray machine, an oxygen monitor, an intravenous monitor, and/or an anesthesia monitor. Further, in certain embodiments, the one or more devices also include a location-determining device 210, an authentication unit 212, an encryption/decryption unit 213, an audio device 214, a video device 216, a display 218 and/or a storage device 220. In one exemplary implementation, the encryption/decryption unit 213 provides symmetric and/or asymmetric encryption to enable more secure communications to/from the one or more medical devices as well as to/from the specialist unit.

In accordance with aspects of the present technique, the interface bank 202 functions as an integrated set of input-output (I/O) data ports that facilitate easy integration and interoperability of the one or more devices connected to or integrated within the patient unit 102. Particularly, in one embodiment, the interface bank 202 receives instructions, user preferences and/or application specific data via the control panel 204 for integrating the one or more medical devices into the sensor unit 208. To that end, the control panel 204 may include, for example, a keyboard, a mouse, a touch screen, a plotter, a graphical pen, a trackball, or any other suitable control device. The control panel 204 allows the user, such as a medical professional, to select and/or add a medical device by using, for example, a graphical user interface (GUI) available on the display 218. The control panel 204 further presents the user with recommended settings on the display 218 for the selected medical device and/or allows the user to explicitly enter desired settings.

Further, by way of an illustrative example, once a medical device is operational, the interface bank 202 is able to remotely receive and/or transmit information from/to the medical device through the RF unit 206. Accordingly, in one embodiment, the RF unit 206 includes, for example, a transceiver with a receiver channel including filters for filtering received signals and one or more amplifiers that condition the received signals into an appropriate format. Additionally, in certain implementations, an analog to digital conversion section may be used to convert the received analog medical device data into appropriate digital formats. Similarly, the RF unit 206 may also include a transmitter channel typically including filters and amplifiers to condition the signals to be transmitted to the medical devices. Further, digital to analog conversion may also be employed on the transmitted signals.

The RF unit 206, in one embodiment, remotely receives and transmits information including, for example, one or more data types from the plurality of medical devices via a communication signal over an available communication channel. As used herein, the term “data types” refers to the various types of data that are communicated between the medical devices, the patient unit 102 and/or the specialist unit 108. In one embodiment, the one or more data types in the information received/transmitted from the patient unit 102 and/or the specialist unit 108 include one or more characteristics corresponding to the communication signal, the plurality of available communication channels and/or network connectivity data.

Additionally, the one or more data types may also include diagnostic information received from one or more medical devices corresponding to the sensor unit 208 and audio, video and image data received/transmitted from the audio device 214 and/or the video device 216. In certain embodiments, the one or more data types may further include location data generated by the location-determining device 210, user preferences and/or application data received from the control panel 204 and diagnostic and/or prognostic data corresponding to the patient unit 102 and/or the specialist unit 108.

In certain embodiments, the patient unit 102 further includes a multiplexer 222 that serves as a gateway for the interface bank 202 to route information including different data types from at least one medical device disposed locally and/or at a remote location. Particularly, the multiplexer 222 ensures desired communication link reliability for routing the information by employing techniques such as error correction and resending data. To that end, in one embodiment, the multiplexer 222 segregates information corresponding to different data types from the received information. The multiplexer 222, thus, may allow the patient unit 102 to determine the data type in the received information. By way of example, the patient unit 102 may determine the received information to include audio, video and image data by analyzing one or more characteristics of the information corresponding to different data types segregated by the multiplexer 222. The multiplexer 222 may also combine information corresponding to two or more different data types into simultaneously transmitted message streams or a multiplexed outgoing message stream.

In accordance with aspects of the present system, the multiplexer 222 segregates and/or combines the information corresponding to different data types according to corresponding QoS profiles. The QoS profiles associated with different data types may be stored in a memory such as the storage device 220. In one embodiment, the QoS profiles are stored to enable a default operating condition of the system 100. To that end, the QoS profiles may include, for example, determined values of QoS parameters such as bandwidth, latency, jitter, loss, throughput, reliability, availability, compression, security, packet size, response time and/or priority.

By way of example, if the system 100 has limited network performance and connectivity information at start-up or during a connection loss, the system 100 may use the stored QoS profiles such as expected data rate, latency, jitter, error rate corresponding to an available communications link, such as cellular GPRS, to begin or continue communicating relevant medical information with the specialist unit 108. Further, the QoS profiles may also include allowable ranges of values of the QoS parameters for communicating different data types such as EKG data, audio data, video data and/or blood pressure information for various medical examinations conducted during different medical scenarios with varying urgency.

The QoS profiles, however, may differ for different data types and different scenarios characterized by factors such as emergency or non-emergency, location, time and other such parameters that may require custom QoS specifications and prioritization. While transmitting compressed video, for example, it may be more important to deliver the video frames in a timely manner even if some of the video frames are lost. However, while transmitting images, transmission reliability to ensure an acceptable quality of the image at a receiver end may be more important than the delay caused by retransmissions. While transmitting EKG signals of an accident victim, however, both timeliness and signal integrity will be of prime concern. Accordingly, the parameters corresponding to the QoS profiles are adjusted to ensure timely, accurate and prioritized communication. It may be noted that different data types may differ in their behavior and resource requirement, thus requiring different types of network services characterized by particular QoS specifications. Additionally, the QoS profiles may also be adapted for each data type based on the network resources available for communication and the medical specialist's requirements.

Accordingly, in one embodiment, the patient unit 102 includes a QoS manager 224 for providing adaptive QoS for communicating information of different data types in different scenarios. Particularly, the QoS manager 224 generates customized QoS profiles for routing information including different data types according to the QoS profile assigned to each data type in different scenarios. To that end, the QoS manager 224 may include one or more microprocessors, microcomputers, microcontrollers, and so forth, for processing the received information. Additionally, in certain embodiments, the QoS manager 224 provides QoS functions corresponding to different internetworking layers of the patient unit 102 that identify the set of QoS parameters for routing a particular data type based on the available network resources and specific user requirements.

Conventional QoS implementations merely prioritize transmission of different data types based on network characteristics or data types. The QoS managers 224 and 324, however, in one embodiment, use certain QoS functions to additionally customize the health information, the customization including but not limited to dynamic prioritization, compression, gating, and error correction coding before transmission. To that end, the QoS functions include instructions and/or policies according to which the QoS parameters in a QoS profile corresponding to a particular data type in a particular situation may be customized.

Particularly, in certain implementations, the patient unit 102 uses the QoS functions to dynamically modify at least a portion of the health information into value factored health information for transmission according to the network near real-time channel characteristics. For example, a subset of the EKG measurements may be a higher priority and can be modified to be encoded and/or compressed according to the network channel characteristics so that it is received by the specialist unit 108 where it can be decoded and/or uncompressed for review and analysis. In another implementation, the imaging data from one or more scans can be set as a higher priority and/or compressed or configured into value factored image information for improved communications.

As used herein, the term “value factored health information” refers to the portion of the health information that is subject to the algorithmic processing that is used to determine some or all of the health information that has a higher priority or value and is customized for transport across the communications channel based on the measured channel characteristics. As previously noted, the measured channel characteristics may include, for example, determined values of QoS parameters such as bandwidth, latency, jitter, loss, throughput, reliability, availability, compression, security, packet size, response time and/or priority. Value factored health information, however, may also be established using one or more other factors. In one embodiment, the value factored health information may be established using data types such as EKG data, audio data, video data and/or blood pressure information for various medical examinations conducted during different medical scenarios with varying urgency. In another embodiment, the value factored health information also includes the input from the medical specialists through the specialist unit 108 that can prioritize or request certain data types from the patient unit 102.

FIG. 3 illustrates a schematic block diagram depicting an exemplary configuration of the specialist unit 108 of FIG. 1 that provides for communications with the patient unit 102. In the presently contemplated configuration, the specialist unit 108 includes one or more components that are substantially similar in structure and function to the components of the patient unit 102 illustrated in FIG. 2. In certain other scenarios, the components corresponding to the specialist unit 108 may be implemented as shared resources. In one embodiment, the specialist unit 108, for example, includes an interface bank 302, a control panel 304 and an RF unit 306 similar in certain respects to the structure and function of the corresponding components of the patient unit 102. The specialist unit 108, however, may not include sensor units or medical devices, such as shown in FIG. 2, as the health information for diagnostic purposes will typically be received from the medical devices 104, 106 coupled to the patient unit 102. Similarly, the specialist unit 108 typically may not include a location-determining device that generates location information corresponding to the specialist unit 108.

Other components of the specialist unit 108 that may be similar to the corresponding components of the patient unit 102 include an authentication unit 312, an encryption/decryption unit 313, an audio device 314, a video device 316, a display 318, a storage device 320 and a multiplexer 322. As previously noted with reference to the encryption/decryption unit 213 of FIG. 2, in an exemplary implementation, the encryption/decryption unit 313 provides symmetric and/or asymmetric encryption/decryption to enable more secure communications to/from the medical devices. To that end, the encryption/decryption unit 313 receives and decrypts the encrypted health information data received from the patient unit 102, thus aiding in secure and authorized data access.

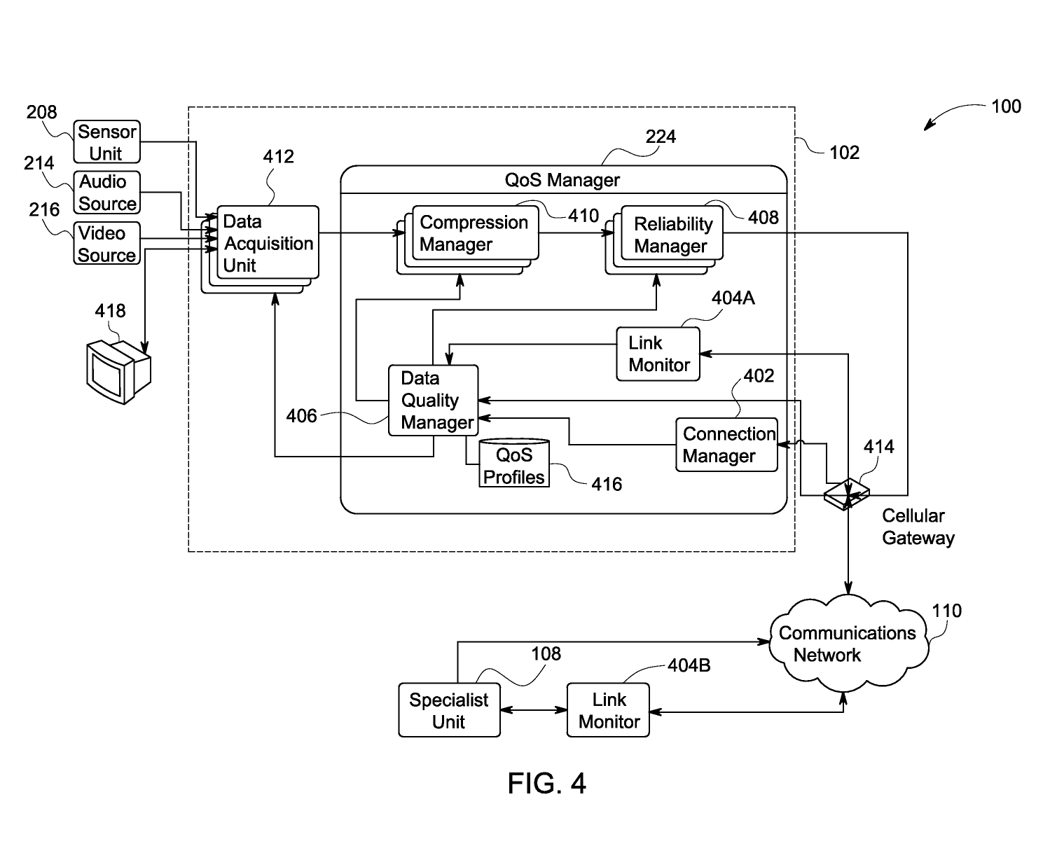

Further, the specialist unit 108 also includes a QoS manager 324 similar to the QoS manager 224 of FIG. 2 for ensuring provision of adaptive QoS for communicating information of different data types in different scenarios. As previously noted, the QoS manager 324 customizes the information including different data types before transmission based on available network characteristics, specialist request and the particular data type being transmitted. An exemplary configuration of a QoS manager for enabling adaptive communication of health information between the patient unit 102 and the specialist unit 108 will be described in greater detail with reference to FIGS. 4-10.

Turning to FIG. 4, a schematic block diagram depicting an exemplary flow of medical information through various components of a health information communications system such as the system 100 of FIG. 1 is presented. The flow of medical information is substantially optimized and controlled by a QoS manager, such as the QoS manager 224 and 324 of FIGS. 2 and 3, in accordance with aspects of the present technique. For clarity, the flow of medical information is described with reference to the QoS manager 224 and other components illustrated in FIG. 2. The following description, however, may also apply to the QoS manager 324 corresponding to the specialist unit 108 illustrated in FIG. 3.

Accordingly, in one embodiment, the QoS manager 224 includes a connection manager 402, a patient link monitor 404A, a data quality manager 406, a reliability manager 408, a compression manager 410 and the data acquisition unit 412 communicatively coupled to each other. In one exemplary implementation, at least some of the QoS manager components communicate over the communications network 110 through a cellular gateway 414. The QoS manager 224 controls transmission of the medical information by dynamically adapting the QoS profiles 416 of the different data types in different scenarios. To that end, the QoS manager 224 uses information determined by the connection manager 402, the link monitor 404A, the data quality manager 406, the reliability manager 408, and the compression manager 410 to dynamically adapt the QoS profiles 416 for communicating specific medical information data types to and from the medical devices that are communicatively coupled to remotely located patients.

Accordingly, in an embodiment, specialized medical services may be provided to the remotely located patients by establishing a remote connection between the patient unit 102 and the specialist unit 108 over the communications network 110. To that end, the connection manager 402 establishes, maintains and/or monitors a connection between the patient unit 102 and the specialist unit 108. Particularly, in an exemplary implementation, the connection manager 402 provides oversight and control to maintain the communications connection even in a resource-constrained environment. By way of example, the connection manager 402 may route medical information through WAN communications with an alternative communication path, such as a WiMax or WiFi network if the original communications channel shows limited connectivity. Similarly, the connection manager 402 adapts the connection parameters to maintain an established connection even if either or both of the patient unit 102 and the specialist unit 108 are mobile to avoid dropouts.

Once the system 100 is initialized, the connection manager 402 continually monitors the connection state. Particularly, in one embodiment, the connection manager 402 determines the connection state based on factors such as received signal strength indication (RSSI), a point-to-point protocol (PPP) connection status and a cellular service class received from, for example, the cellular gateway 414. The connection manager 402, thus, may rapidly detect the connection state and re-establish a lost connection. Particularly, in certain embodiments, the connection manager 402 may include a memory section to buffer the data types and re-transmit the data types once the communication channel is re-established. Additionally, the connection manager 402 may provide a notification to the patient unit 102 and/or the specialist unit 108 regarding the connection state being established, lost and/or re-established. In certain other embodiments, the connection manager 402 may also provide cellular usage monitoring and control, roaming indicators, time-outs for lack of activity, and other suitable functions.

Particularly, in one exemplary implementation, the connection manager 402 manages the security aspects of the connection during the connection establishment by enforcing authentication, authorization and encryption. The connection manager 402, thus, ensures secure communication of the medical information between authorized and authenticated patient and specialist units to prevent any misuse. To that end, the connection manager 402, in one embodiment, may accommodate symmetric or asymmetric encryption using, for example, the encryption/decryption units 213 and/or 313 illustrated in FIGS. 2 and 3. Particularly, the connection manager 402 employs the symmetric and/or asymmetric encryption to provide enhanced security for the communications between the patient unit 102 and the specialist unit 108 based on the specific nature of the information being communicated.

Further, the patient link monitor 404A continually monitors the communications channels to determine channel performance characteristics for optimizing the transmission of the medical information over a communications channel. To that end, the patient link monitor 404A uses a desired frequency and/or a dynamically varying measurement frequency for the channel characteristics measurements based upon the communications channel performance compared to the transmitted data. The measurement frequency may also be varied based on one or more of the type of exam being undertaken, the particular data type being communicated and/or the specialist's request.

Accordingly, the patient link monitor 404A, in one aspect, determines metrics corresponding to channel characteristics such as a transmission rate in bits per second, channel latency in milliseconds, jitter in milliseconds and packet error rate in percentage of packets lost per second. The patient link monitor 404A then uses the determined metrics to generate a capacity profile corresponding to a specific communications channel. In certain embodiments, the patient link monitor 404A combines the measurements using a single test stream rather than separate test streams for different channel characteristics. Alternative embodiments may employ the medical data itself as the test stream for optimizing channel utilization.

Further, the system 100 may include a separate specialist link monitor 404B to segregate the link measurements to determine channel performance at the patient's end and the specialists end, thus facilitating more accurate routing decisions. To that end, in one embodiment, the patient link monitor 404A determines the network channel characteristics independent of the specialist unit 108. The patient link monitor 404A, for example, can obtain network channel characteristics from existing network devices. Further, in another embodiment, the specialist link monitor 404B determines the network channel characteristics independent of the patient unit 102. Although FIG. 4 illustrates two link monitors 404A and 404B, certain other embodiments may employ only a single link monitor or more than two link monitors to measure channel performance at different points in the communications network 110. In one embodiment, for example, the specialist link monitor 404B is integrated with the specialist unit 108. In addition, the link monitors 404A, 404B in another example are partially or wholly integrated with networking hardware of the communications network such that certain network functionality is embedded with the network hardware.

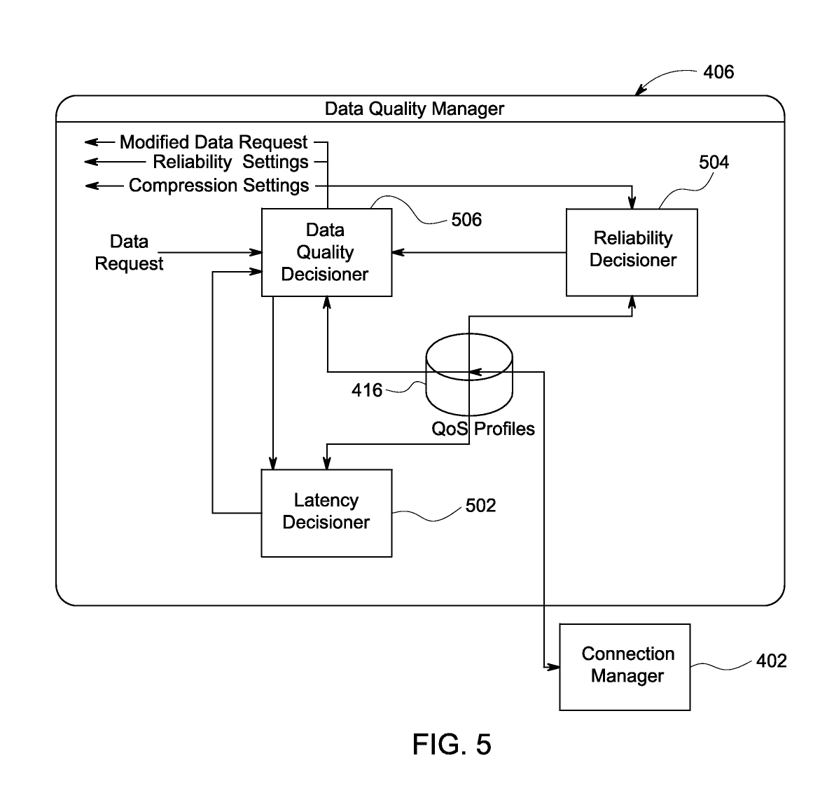

Conventional telemedicine systems merely reprioritize the data transmission based on the detected channel characteristics. The data quality manager 406 of the present system, however, uses the channel characteristics, along with other parameters such as data types, to customize the data to ensure that at least critical medical information is communicated accurately between the patient unit 102 and the specialist unit 108 over an available communications channel. An exemplary customization of the medical information by the data quality manager 406 based on the channel characteristics and other application parameters is described in greater detail with reference to FIG. 5.

FIG. 5 illustrates an exemplary representation of the data quality manager 406 illustrated in FIG. 4. The data quality manager 406 provides overall system control and decisioning. Particularly, the data quality manager 406 provides real-time control for the data flow by dynamically adjusting the QoS profiles 416 that specify which data types and how a specific data type is to be transmitted to match the communications channel performance capabilities. To that end, the data quality manager may be coupled to a database in a memory device, such as the storage device 220 of FIG. 2, that stores default values for control and rules associated with particular data types in the corresponding QoS profiles 416.

The QoS profiles 416 may further include a capacity profile, a latency profile and a reliability profile that specify default values corresponding to QoS parameters for a particular data type in a particular scenario. The default values of the QoS parameters may further be customized during operation based on the specific scenario, such as a relative priority of a data type, type of exam, location specific criteria, a specialist's request and other suitable parameters. The customizations may update the QoS profiles 416 by changing a transmission priority of a particular data type, allow customization of the medical information to transmit a subset/customized form of the medical information and/or provide delayed or incremental transmission based on channel characteristics. Further, the QoS profiles 416 may be stored in the database along with recent measurements and historical information along with their corresponding timestamps. The data quality manager 406 uses the stored QoS profiles to facilitate system start up, operation and shut down even when no current measurements are available or subsequent to operation time-outs.

To that end, the data quality manager 406 may employ, for example, an operations history module (not shown) that may form part of a memory, such as the storage device 220 of FIG. 2, for storing the history of settings and selections by a system operator. The stored information may be used to review system operation and performance, recalibrating system parameters and/or troubleshooting system errors. In certain embodiments, the operations history module may further include data types and recorded medical details for generating payment data for the provision of the medical services. Additionally, the data quality manager 406 may integrate the stored medical information with information from patient medical records and referral and ordering systems for legal purposes, for facilitating prognostic patient evaluation and/or performing analyses for further improving remote patient care.

Accordingly, the data quality manager 406 provides system control and decisioning based on operational data received from other system components or implementing the controls through the other system components. In one embodiment, these system components include the patient link monitor 404A, a latency decisioner 502, a reliability decisioner 504 and a data quality decisioner 506. Particularly, the data quality manager 406 uses data received from these system components such as a type of a connection used at the cellular gateway 414, link metrics and data acquired by the data acquisition unit 412 to provide desired system control and decisioning. Further, unlike conventional telemedicine systems, the data quality manager 406 uses adaptive and intelligent protocols for dynamically customizing the medical information for transmission based on the data type, the medical exam, the type of channel and a specific request from the specialist.

Accordingly, in one embodiment, the data quality manager 406 determines which data types may be transmitted over an available channel. To that end, the latency decisioner 502 generates a latency profile based on measured latency values and determines if the measured latency is acceptable for the data types being delivered over the communications channel. Accordingly, the data quality manager 406 customizes the data to match the channel latency performance. Particularly, the data quality manager 406 determines if a specific data type will be sent as requested, more compatible or alternate forms of data will be sent or if nothing will be sent based on the measured channel latency performance. By way of example, if the latency of the communications channel over which audio data is to be transmitted is determined to be over a threshold value, for example over two seconds, the data quality manager 406 may either switch the communications mode to push-to-talk (PTT), activate instant messaging (IM) and/or deactivate audio transmission altogether.

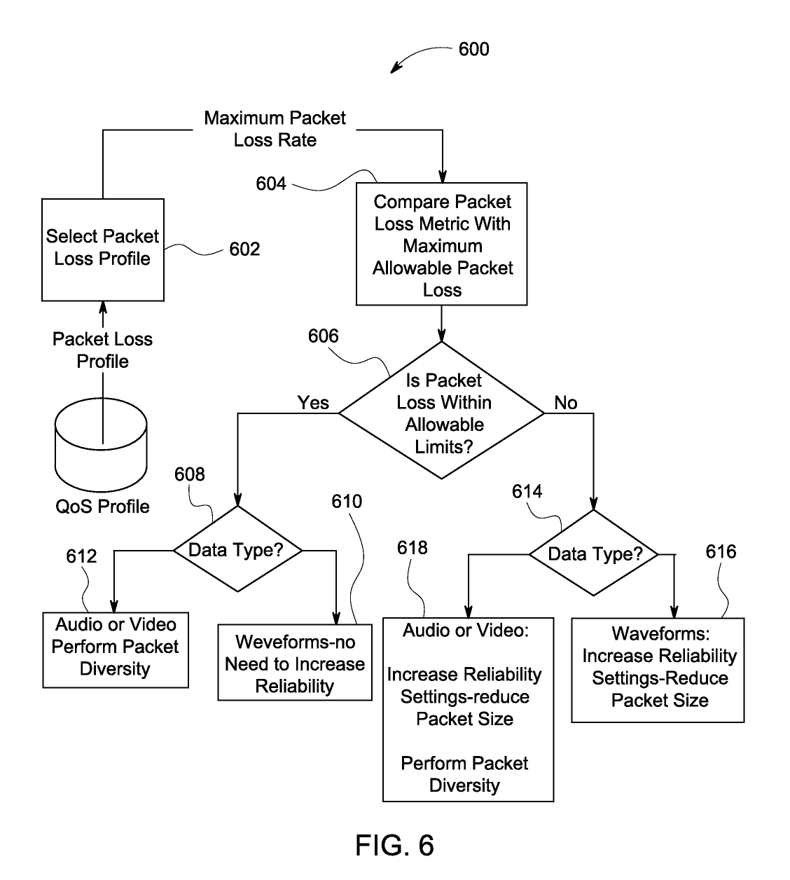

Further, the reliability decisioner 504 performs the necessary computations to increase the reliability of the data being sent over the communications channel. Particularly, the reliability decisioner 504 manipulates and integrates, for example, forward error correction codes, data interleaving, packet lengths and packet resends to minimize overheads and optimize data robustness given the error rate of the available communications channel. An exemplary operation of the reliability decisioner 504 is discussed in greater detail with reference to FIG. 6.

FIG. 6 illustrates a flow diagram 600 depicting an exemplary operation of the reliability decisioner 504 of FIG. 5. In this illustrative example, the reliability decisioner 504 defines the reliability protocols to be implemented and the respective settings for each of the active protocols. In certain cases, unique protocols are applied on each data type as determined by the current state of the communications channel, the current examination task, and the type of data being sent. To that end, at step 602, a packet loss profile for a particular data type is selected. Further, at step 604, the measured packet loss on a current communications channel is compared with a maximum allowable packet loss. To that end, the reliability decisioner 504 may access the default values for the maximum allowable packet loss for a particular communications channel and a particular data type from a database stored on a memory device coupled to the system 100.

If the packet loss is within allowable limits, at step 606, the reliability decisioner 504 determines the data type corresponding to the medical information to be transmitted at step 608. If the determined data type corresponds to waveforms, the reliability decisioner 504 retains the reliability settings at step 610. If the determined data type corresponds to audio or video, however, the reliability decisioner 504 performs packet diversity at step 612 to improve the reliability of the data being transmitted over the communications channel.

Referring back to step 606, if the packet loss is determined to be outside allowable limits, at step 614, the reliability decisioner 504 determines the data type corresponding to the medical information to be transmitted. If the determined data type corresponds to waveforms, for example, the reliability decisioner 504 adjusts the reliability settings at step 616 to provide improved reliability by reducing packet size. If the determined data type corresponds to audio or video, however, the reliability decisioner 504 performs packet diversity at step 618 to improve the reliability of the data being transmitted over the communications channel. Additionally, the reliability decisioner 504 adjusts the reliability settings to provide improved reliability by reducing the corresponding packet size.

Once the system is initialized, the reliability decisioner 504 uses all or some of the specified input data and the rules library to implement the optimum set of reliability protocols for each of the data classes being sent. Particularly, the reliability decisioner 504 uses the link metrics, reliability protocols and latency rules corresponding to each data type and/or a default set conditions defined for each of the possible cellular connection types and the type of medical exam being conducted. The reliability decisioner 504 uses such information to generate and/or update reliability profile settings for each available data type in a specified scenario.

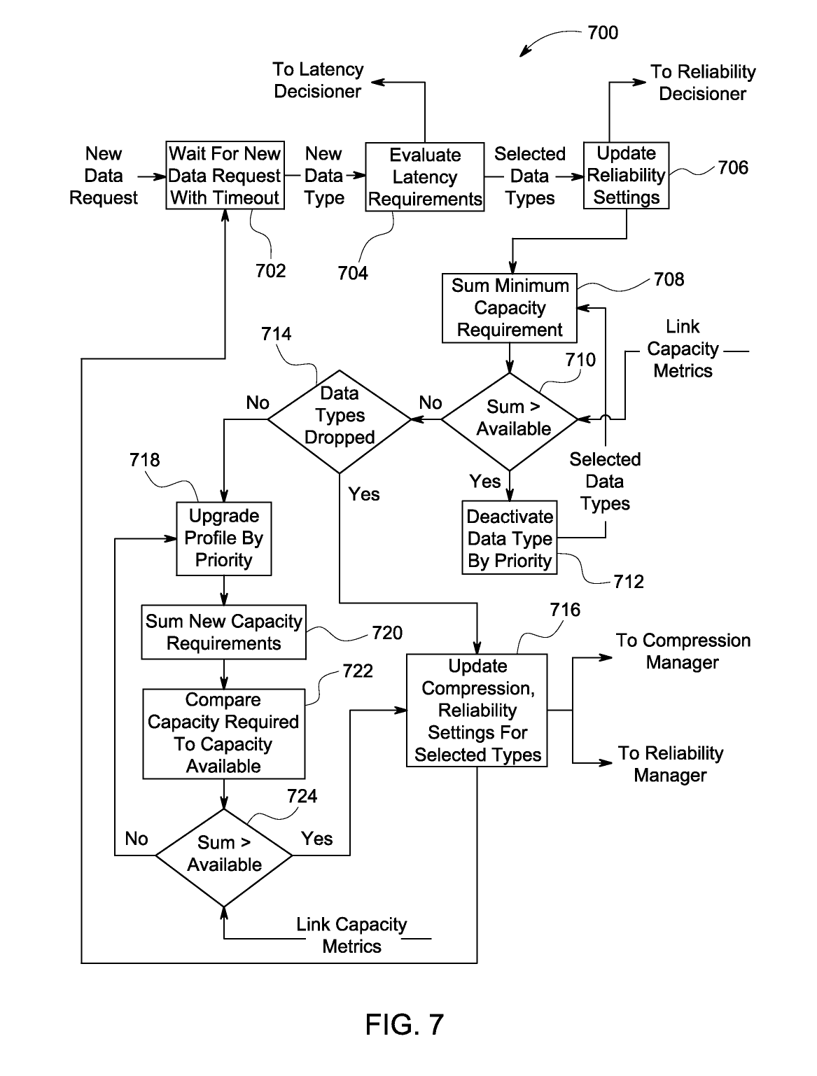

In accordance with aspects of the present technique, the data quality manager 406 uses the latency profile and the reliability profile generated by the latency decisioner 502 and the reliability decisioner 504, respectively to evaluate the overall system control and decisioning operations. To that end, the data quality manager 406 employs the data quality decisioner 506 that provides near real-time data flow controls by dynamically adjusting what and how to send the necessary data to match the communications channel performance capabilities. An exemplary operation of the reliability decisioner 504 is described in greater detail with reference to FIG. 7.

FIG. 7 illustrates a flow diagram 700 depicting an exemplary operation of the data quality decisioner 506 of FIG. 5. At step 702, the data quality decisioner 506 waits for a new data request for transmission of the requested medical information between the patient unit 102 and the specialist unit 108. The data quality decisioner 506 initially sets default priorities, throughput and latency values based on network connection characteristics and data type. Upon receiving the data request at step 704, however, the data quality decisioner 506 forwards the data types corresponding to the data request to the latency decisioner 502 for evaluating corresponding latency requirements. As previously noted, the latency decisioner 502 generates a latency profile for the received data types based on the link metrics measured on the available communications channels.

Subsequently, the data quality decisioner 506 receives the measured latency values for specific data types from the latency decisioner 502. Further, at step 706, the data quality decisioner 506 forwards the latency values along with the data types in the data request to the reliability decisioner 504 for adjusting corresponding reliability parameters as described with reference to FIG. 6. Based on the reliability parameters determined for each data type in the requested data, the data quality decisioner 506 computes a sum of a minimum capacity requirements corresponding to each data type in the requested data at step 708. At step 710, the data quality decisioner 506 then compares the computed sum to the available channel capacity as determined by the link monitor 404. If the computed sum is greater than the available channel capacity, at step 712, the data quality decisioner 506 updates the QoS profiles for the requested data by deactivating one or more data types based on priority until the remaining data satisfies the channel capacity.

To that end, the data quality decisioner 506 determines the priority of the different data types based on default rules corresponding to each data type, type of medical examination being undertaken, network parameters, specific information requests from the medical specialist, emergency nature of transmission, or combinations thereof. In one embodiment, the rules, protocols and parameters used in the priority evaluation are stored in a database in a storage device coupled to the data quality manager 406. The data quality decisioner 506 continually updates the rules, protocols and parameters based on the changing nature of the communications channel and the specific medical situation.

Further, if the computed sum is less than the available channel capacity, at step 714, the data quality decisioner 506 verifies whether any data types have been dropped. If any of the data types have been dropped, for example to match channel capacity, the data quality decisioner 506 updates compression settings and reliability settings in the QoS profiles corresponding to the selected data types at step 716. The updated compression settings and reliability settings are then passed onto the compression manager and the reliability manager, respectively for implementation. If none of the data types have been dropped, however, the data quality decisioner 506 upgrades the QoS profiles for each of data types based on priority at step 718.

Further, at step 720, the data quality decisioner 506 computes a sum of the minimum capacity requirements corresponding to each of the upgraded data types. The data quality decisioner 506 then compares the computed sum to the currently available channel capacity metrics at step 722. If the computed sum is lesser than the available channel capacity, the data quality decisioner 506 continually upgrades the QoS profiles for each of data types based on priority at step 718 until the requested data matches the channel capacity. However, if the computed sum is lesser than the available channel capacity, the data quality decisioner 506 updates the compression settings and reliability settings in the QoS profiles corresponding to the selected data types as described with reference to step 716. As previously noted, the updated compression settings and reliability settings are then passed onto the compression manager and the reliability manager, respectively for implementation.

The data quality decisioner 506, thus, uses all or some of the specified input data and the rules library to establish optimum control parameters for different components of the data quality manager 406. Particularly, the data quality decisioner 506 defines weightings and acceptable threshold limits for each of the driving functions employed for determining what and how to communicate the necessary medical information between the patient unit 102 and the specialist unit 108 in a particular scenario. To that end, the driving functions include data requests from the medical specialist, medical examination type data needs and maximum allowable compression, bandwidth, latency, packet error rates and data rates compatible with user expectations and channel performance. The data quality decisioner 506 applies weights and limits associated with the driving functions based on varying examination tasks, channel capacity and data types. Particularly, the data quality decisioner 506 enables the data quality manager 406 to control the frequency and nature of update to provide a near optimal set of data controls that enable the specialist to provide an effective examination given the dynamic constraints of the WAN communications channel available.

Referring back to FIGS. 1-4, the data quality manager 406 modifies the data request based on the driving functions and the updated control parameters specified by the data quality decisioner 506. Upon receiving the modified request from the data quality manager 406, the data acquisition unit 412 acquires the necessary data from sensors or medical devices communicatively coupled to the patient unit 102. To that end, the data acquisition unit 412 interfaces with various medical devices and the sensor unit 208 wherein the local medical devices and the sensor unit 208 includes devices such as a magnetic resonance imaging (MRI) system, a computed tomography (CT) system, an ultrasound system, an EKG machine, a blood pressure monitor, an X-ray machine, an oxygen monitor, an intravenous monitor, and/or an anesthesia monitor. The data acquisition unit 412 is also communicatively coupled to devices such as the audio device 214, the video device 216 and a medical diagnostic display unit 418 to communicate such data as medical, audio, video, EKG, SpO2, respiration and physiological data. Although FIG. 4 depicts only three data sources, the data acquisition unit 412 may interface and acquire data from digital stethoscopes, thermometers, ultrasound systems, digital X-ray machines and other electronic records.

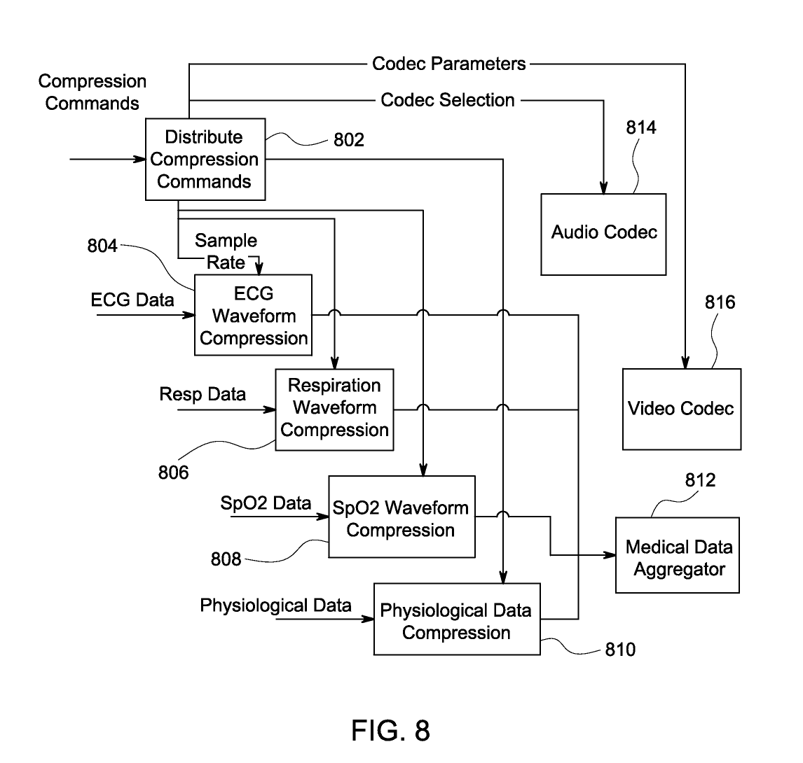

Particularly, the data acquisition unit 412 receives data selection commands from the data quality manager 406 to acquire the requested medical information. To that end, the data acquisition unit 412 selects or discards each individual data stream based the received commands. The data acquired by the data acquisition unit 412 is then transmitted to the compression manager 410 that appropriately compresses the medical information for transmission so as to match channel capacity, yet preserve signal integrity. An exemplary operation of the compression manager 410 is discussed in greater detail with reference to FIG. 8.

FIG. 8 illustrates a flow diagram 800 depicting an exemplary operation of the compression manager 410 of FIG. 4. Accordingly, at step 802, the compression manager 410 distributes the compression commands and/or settings received from the data quality manager 406 for each selected data type into different processing channels. In certain embodiments, the compression manager 410 combines the data sources to provide statistical multiplexing of the various data types to optimize data rate variability such that peaks of one data type align with valleys of another data type. By way of example, the data types include audio data, video data, an EKG waveform, a respiration waveform, an SpO2 waveform and other physiological data. Although, FIG. 8 illustrates only six data types, the compression manager 410 may process fewer or more data types based on the examination type, a specialist's request and/or channel characteristics.

The compression manager 410 compresses the various waveforms by modifying corresponding sample rates provided by the data quality manager 406. Accordingly, at steps 804, 806 and 808, the compression manager 410 modifies the sample rates specified by the data quality manager 406 for an EKG waveform, a respiration waveform and an SpO2 waveform acquired by the data acquisition unit 412 from the corresponding data source. To that end, the compression manager 410 queues received data and passes only the data that satisfies the corresponding sample rate. In certain embodiments, the compression manager 410 further improves waveform compression by using more complex wavelet or other compression transforms.

Similarly, at step 810, the compression manager 410 queues physiological data in a buffer and compresses the physiological data by modifying a rate at which updated data is sent or by a change detect. In one embodiment, change detect corresponds to a determination as to whether there was a change in the data that requires an update to be communicated. The compression manager 410 then passes the latest data or data received in a particular time period based upon corresponding timestamps. The compressed EKG waveform, respiration waveform, SpO2 waveform and the physiological data are forwarded to a medical data aggregator 812 that, in turn, transmits the medical data to the specialist unit 108.

Further, the compression manager 410 transmits the codec selection settings received from the data quality manager 406 to an audio codec 814 in the data acquisition unit 412. The audio codec 814 compresses the audio data based on the received settings and transmits the compressed audio to the specialist unit 108. Similarly, the compression manager 410 transmits the codec parameters received from the data quality manager 406 that define a video compression type to a video codec 816. In one embodiment, the video codec 816 resides in the data acquisition unit 412. The video codec 816 compresses the video data based on the received parameters and transmits the compressed video to the specialist unit 108. The compression manager 410 provides an ability to control the data bit rate to match the available channel capacity. The compression manager 410, thus, ensures reliable and secure transmission of medical information between the patient unit 102 and the specialist unit 108 in different situations without incurring excessive networking and computational costs.

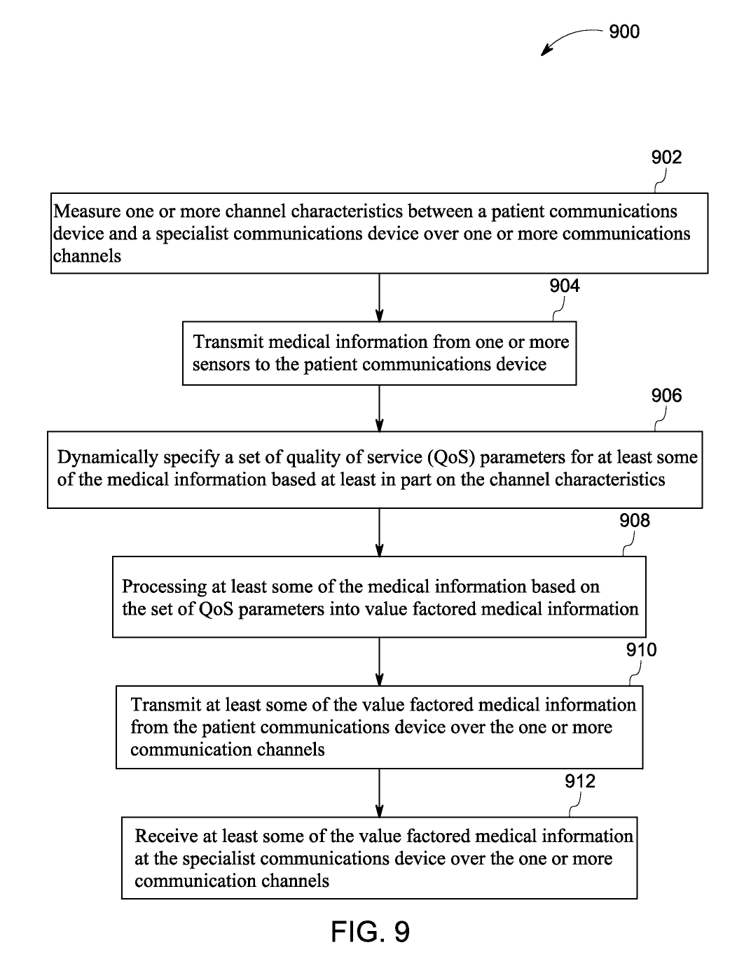

Turning to FIG. 9, a flow chart 900 depicting an exemplary method for communicating health information is presented. The exemplary method may be described in a general context of computer executable instructions on a computing system or a processor. Generally, computer executable instructions may include routines, programs, objects, components, data structures, procedures, modules, functions, and the like that perform particular functions or implement particular abstract data types. The exemplary method may also be practiced in a distributed computing environment where optimization functions are performed by remote processing devices that are linked through a communications network. In the distributed computing environment, the computer executable instructions may be located in both local and remote computer storage media, including memory storage devices.

Further, in FIG. 9, the exemplary method is illustrated as a collection of items in a logical flow chart, which represents operations that may be implemented in hardware, software, or combinations thereof. In the context of software, the blocks represent computer instructions that, when executed by one or more processing subsystems, perform the recited operations. The order in which the exemplary method is described is not intended to be construed as a limitation, and any number of the described blocks may be combined in any order to implement the exemplary method disclosed herein, or an equivalent alternative method. Additionally, certain blocks may be deleted from the exemplary method without departing from the spirit and scope of the subject matter described herein. For discussion purposes, the exemplary method is described with reference to the implementations of FIGS. 1-8.

The exemplary method aims to enable a health information communications system such as the system 100 of FIG. 1 to facilitate provision of medical services of a desired quality over unreliable and/or constrained networks. As previously noted, the system may be implemented in multiple devices to allow bidirectional communication between a patient communications device such as the patient unit 102 and a specialist communications device such as the specialist unit 108 of FIGS. 1-3.

In one embodiment, when a patient requires medical attention, a caregiver or the patient initiates processing of patient data, which may retrieve patient's prior medical records for evaluation. To that end, a connection manager such as the connection manager 402 of FIG. 4 communicatively couples the patient unit to the specialist unit over an available communications channel. In one embodiment, the connection manager uses specified authentication, authorization and security protocols to establish a secure and reliable communications channel for transmission of the medical information between the patient unit and the specialist unit. The connection manager, in certain embodiments, continually monitors the connection state and ensures re-establishment of a dropped connection. In such a scenario, the connection manager may further notify the patient unit and the specialist unit about the connection state and the actions being undertaken.

At step 902, the system employs the patient communications device and/or the specialist communications device to measure one or more channel characteristics corresponding to one or more communication channels in the communications network. Particularly, the patient communications device and/or the specialist communications device measure channel characteristics between a patient unit and a specialist unit coupled over the one or more communications channels. As previously noted, the one or more channel characteristics include bit rate, latency, jitter, retries, packet sizes, lost packets and packet errors. Accordingly, in one embodiment, the patient communications device and/or the specialist communications device corresponds to the patient link monitor 404A and the specialist link monitor 404B, respectively illustrated in FIG. 4. In another embodiment, the patient communications device resides as certain hardware and software that is integrated or coupled to a medical device providing the noted communications capabilities. Similarly, the specialist communications device, in a further embodiment, is certain hardware and software providing the noted communications capabilities.

Additionally, at step 904, the patient communications device receives medical information from one or more sensors. The one or more sensors, for example, include medical devices such as an MRI system, a CT system, an ultrasound system, a blood pressure monitor, an X-ray, a video device, an audio device, a communications system, or combinations thereof. Specifically, in one embodiment, the patient communications device receives the medical information from the one or more sensors based on a patient's medical examination. To that end, the sensors or medical devices can be selectively activated, continuously transmitting at various cycles, or otherwise communicating data based upon default settings associated with the medical exam and/or specialist's requests.

By way of illustrative example, the one or more sensors generate the medical information based on the specific medical exams undergone by the patient for evaluating the patient's condition. The patient communications device receives the medical information including one or more data types over a communication channel integrated within the interface bank 202. The patient interface bank 202, in turn, is communicatively coupled to a router such as the multiplexer 222 of FIG. 2 for differentially routing information including different data types. Accordingly, in one embodiment, the router segregates information corresponding to different data types from the received medical information. The router, thus, enables the patient unit to determine the specific data types in the received medical information. The router may also combine information corresponding to two or more different data types into simultaneously transmitted message streams or a multiplexed outgoing message stream. Particularly, the router segregates and/or combines the information corresponding to different data types according to corresponding QoS parameters.

Accordingly, at step 906, the system employs a QoS manager, such as the QoS manager 224 of FIG. 2, to dynamically specify a set of QoS parameters for some or all of the medical information based at least in part on the channel characteristics. It should be noted that, in certain embodiments, there may be a large volume of health information and only a subset of the health information is value factored so as to be processed using the QoS parameter processing. In one embodiment, the QoS manager dynamically specifies the QoS parameters for routing the medical information corresponding to each data type. Specifically, the QoS manager specifies the QoS parameters based on the measured channel characteristics, the one or more data types, a type of medical examination being undertaken, a data request from the specialist, location, user preferences and/or application settings.

Further, in certain embodiments, the QoS manager specifies the set of QoS parameters for each of the data types by providing one or more customizable QoS functions to the different “International Organization for Standardization” (ISO) 7498 internetworking layers. By way of example, the QoS manager provides the upper ISO layers with one or more QoS functions for specifying the QoS parameters for a particular data type as a “required QoS” or a “best effort QoS.” The QoS function may further be customized based on situational dependence and/or required compression. By way of example, when the system determines a signal for transmission to be an EKG signal, the QoS manager customizes the QoS function to specify the QoS parameters as “required QoS.” The system therefore, will transmit the EKG signal over a communication channel with a bit rate that ensures a specified quality of the EKG signal on receipt.

To that end, the QoS manager provides the lower ISO layers with QoS functions for monitoring and specifying the QoS parameters such as bit rate, latency, jitter, retries, packet sizes, lost packets, and packet errors. By way of example, upon determining that the signal being transmitted is an EKG signal, the QoS manager may specify an appropriate packet size, a desired number of retries, desired bit rate, and error correction based on the latency, jitter and the bandwidth corresponding to the available communication channel for reliably transmitting the EKG signal. The EKG signal, thus transmitted by the patient unit is received point-by-point and is plotted as an EKG waveform on a display on the specialist unit.

In certain embodiments, the QoS manager further customizes the QoS functions to identify QoS parameters for the EKG signal based on an emergency or a non-emergency nature of the transmission and/or high-level compression rules such as allowance or disallowance of lossy compression. In case of an emergency situation such as an accident, if the EKG signal cannot be sent with “required QoS,” the QoS function may specify the QoS parameters that enable EKG signal transmission as “best effort QoS.” Particularly, when transmitting the EKG data as “best effort QoS,” the present system provides a notification to a medical professional or a user of the specialist unit about the inability to currently comply with standard specifications for transmitting the EKG signal. The notification may further request the user/medical professional to prioritize specific region of interest or specific data corresponding to the EKG signal for subsequent viewing and/or analysis.

Accordingly, at step 908, the QoS manager processes some or all of the medical information into value factored medical information. To that end, the value factored health information, for example, can be subject to compressing, encoding, encryption, error correction, and interleaving or otherwise processed and prioritized for optimal communication. By way of example, the QoS manager initially transmits the EKG signal with low quality and resolution along with a notification to the medical professional to indicate a region of interest (ROI) on the EKG waveform. The medical specialist uses a control panel and/or the display on the specialist unit to indicate a ROI such as the R-interval of the EKG waveform. By way of example, the medical specialist indicates the ROI by marking a circle around an appropriate location on the received image of the EKG waveform. The specialist unit then transmits the ROI information back to the patient unit, which subsamples the EKG image data and transmits the ROI area of the EKG waveform to the specialist unit with a relatively higher resolution. Alternatively, the medical specialist may indicate a tolerance for delay in receiving the entire EKG waveform with better resolution by selecting appropriate functions on the display of the specialist unit. Accordingly, the QoS manager customizes the QoS function to identify a set of parameters that facilitate a lossless transmission of the EKG signal over a communication channel that ensures reliability of information received by the specialist unit.

Similarly, the QoS manager, in one embodiment, provides the middle ISO layers with one or more QoS functions for specifying the QoS parameters that address considerations such as a maximum tolerable packet loss rate, prioritized versus guaranteed delivery, and position-time dependence. In one embodiment, the present system tracks lost or erroneous data over a particular communication channel and stores the tracked information in a storage device. The QoS manager then uses the stored data to dynamically customize the QoS functions to identify appropriate QoS parameters such as a resend rate and a required error correction for transmitting a particular data type over the particular communication channel.

Further, in one embodiment, the QoS manager customizes the QoS functions to identify QoS parameters that provide guaranteed or prioritized delivery for transmitting information of a particular data type over a communication channel. By way of example, a medical specialist may request for an EKG signal with ambient image, audio and video at the patient's location to perform a remote diagnosis of a patient's condition. In a non-emergency scenario, for example, the QoS manager may specify a set of QoS parameters that utilize a channel capable of simultaneously transmitting the EKG, video and audio data.

A communication channel that can simultaneously transmit EKG, audio, video and image data, however, may be unavailable at the time of the request. The QoS manager, therefore, may customize the QoS functions to identify parameters that prioritize transmission of the different data types according to the corresponding QoS parameters. By way of example, the QoS functions may identify QoS parameters that transmit the EKG signal at higher bit rates while providing lower quality transmission of the audio data and the video data. Accordingly, in one embodiment, the QoS functions facilitate classification of the customized data packets into different service classes based on desired transmission priority.

Next, at step 910, the QoS manger transports or routes the value factored medical information corresponding to each data type from the patient communications device over the available communication channel. Particularly, using the specified QoS parameters, the present system may use ad-hoc multi-hop communications to reliably and expeditiously communicate high priority and mission critical data. By way of example, the present system may initially determine availability of appropriate communication links and corresponding characteristics in the vicinity. In case of limited network connectivity, the present system may track closely available systems such as a WiMax or WiFi network nearby via a location-determining device to setup a transmission channel through the tracked system for communicating the high priority data to the specialist unit.

In certain embodiments, the QoS manager routes the value factored medical information based on the location of the patient unit using a location-determining device and/or the time of the transmission of the health information. To that end, the location-determining device includes a global positioning system (GPS), an IP address of the present system, a communications base station or any other suitable device that communicates location information to the present system. Particularly, in one prognostic embodiment, the present system catalogues the communication channel quality during different times during the day and different locations of transmission. The present system then uses the catalogued information to anticipate a drop in channel propagation quality, thereby initiating a handoff to obviate the anticipated QoS problems. This prognostic determination can lead to more robust communications as the periodic and/or repeatable network downgrades can be avoided. The present system, thus, ensures transmission of the value factored medical information securely and reliably in different scenarios using adaptive QoS parameters to enable provision of specialized medical services to a remotely located patient who may be in urgent need of medical assistance.

Further, as noted in step 912, at least some of the value factored information routed by the QoS manager is received by the specialist communications device. In one embodiment, the specialist communications device further processes the value factored health information on receipt. The specialist communications device, for example, subjects the received value factored health information to decompressing, decoding, decryption, de-interleaving and/or any other suitable processing for rendering the health information in a form useful for medical diagnosis. A medical specialist or practitioner may use this information for diagnosing the health of the patient. In certain embodiments, the present system also allows the medical specialist to forward the information to another medical professional for seeking a second opinion by prioritizing the transmission of the different data types. Alternatively, the medical specialist may transmit information corresponding to further audio, video or data requests, desired quality parameters and prioritization corresponding to the requested data and/or the diagnosis to the patient communications device. Particularly, the medical specialist may prioritize the transmission of the information via a control panel and/or selectable menu options available on a corresponding display.

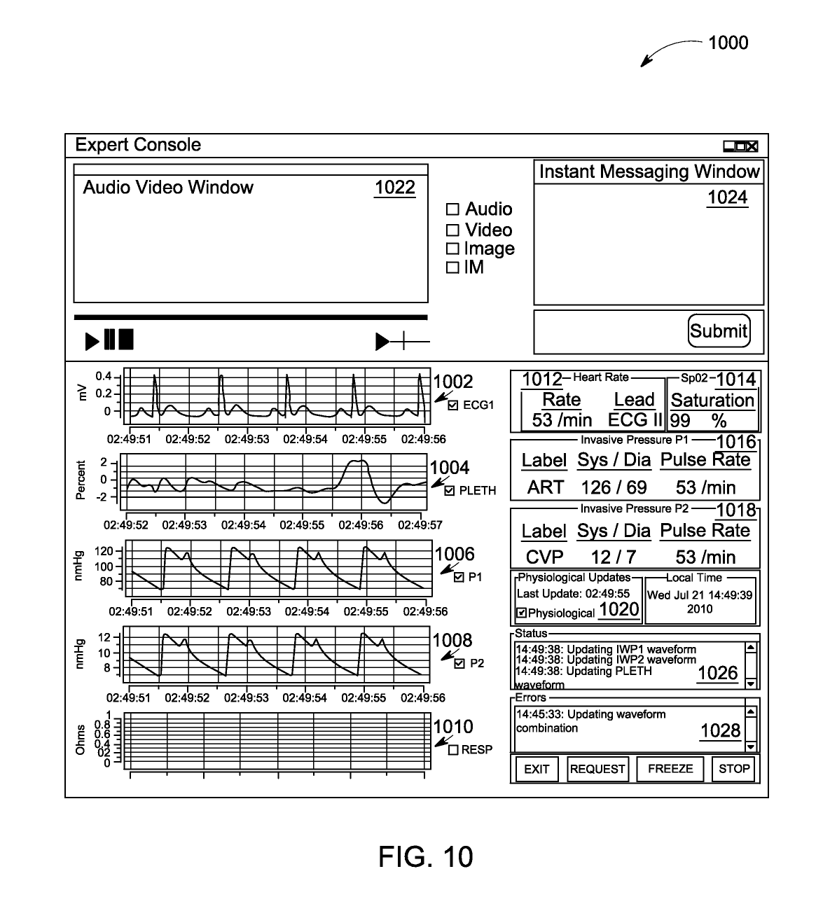

Further, FIG. 10 illustrates an exemplary display 1000 on the specialist unit that allows a medical specialist to provide specialized medical consultation to a remotely located patient. In certain embodiments, however, one or more aspects of the display 1000 may similarly be included in a display on the patient unit as well. Particularly, in one embodiment, the display 1000 displays the received information, for example, through a user-friendly GUI that is easily understood by a medical professional and/or any other authorized user. By way of example, EKG, PLETH (blood oxygen level), P1 (blood pressure), P2 (blood pressure) and respiration signals may be displayed as selectable waveforms in the display areas 1002, 1004, 1006, 1008 and 1010. Further, heart rate, blood pressure, and other physiological data updates may be displayed numerically on the screen in the display areas 1012, 1014, 1016, 1018 and 1020.

In certain embodiments, the display 1000 further provides one or more analysis functions for medical images and EKG signals, for example, to facilitate “R-interval” extraction, ROI selection and edge detection. To that end, an audio-video window 1022 available on the display 1000 enables a patient, a user and/or a medical specialist to alter a frequency and a quality of images transmitted by the patient unit. Further, the display 1000 enables the medical specialist to selectively turn on or turn off waveforms and numerical vital signs information to prioritize the data being sent by the patient unit. To that end, the display 1000 may also display communication channel characteristics with corresponding time stamps for troubleshooting connectivity performance. In the case of audio communication, the data transmission mode may be changed in resource-constrained environments to instant messaging (IM) through an IM window 1024.

Such bidirectional QoS control enables dynamic reprioritization of data transmission to optimize available bandwidth utilization and data throughput. In addition to displaying the information, in certain embodiments, the present system transmits the information to another system communicatively coupled to the present system. Further, the present system may also triggers an alarm, generate status messages in a status window 1026, notify errors in an error window 1028, forward a message to a mobile device, and/or store the medical information in the storage device. The system uses the stored medical information for generating payment data for the provision of the medical services. Additionally, the system 1000 may also integrate the stored medical information with information from patient medical records and referral and ordering systems to facilitate analysis for further improving remote patient care. In certain embodiments, the display 1000 may further include customizable options for remotely controlling and/or configuring sensors coupled to patient module.

The embodiment illustrated in FIG. 10 illustrates only a few exemplary configurable options on the display 1000. In alternative embodiments, however, the display 1000 may include specific options that allow the users to dynamically update the rules, protocols and parameters corresponding to transmission of different data types. The graphical user interface of the display 1000 for the patient unit or specialist unit are configured to provide a robust and flexible interface for the user. Unlike conventional telemedicine systems that use rigid proprietary algorithms, the display 1000 along with the data quality decisioner enables a specialist and/or an end-user to easily and efficiently expand and/or customize the autonomous system processing to include several new protocols. Specifically, the new protocols are devised for enabling transmission of medical information in various types of medical situations even in a resource-constrained environment. Additionally these configuration settings may be updated remotely through an enterprise system to comply with administrative policies or ease of deployment of performance enhancements.

The present system, thus, provides the ability to adapt to changing network environments and medical requirements by dynamically customizing the QoS parameters for transmitting different kinds of health information. Further, implementation of the present system at edge devices ensures provision of reliable medical services without depending on any centralized functions from an overloaded network core. By way of example, the present system implemented in a mobile medical device and a physician's desktop may allow use of valuable pre-hospital transport time for diagnosing and evaluating trauma patients en route, thereby substantially increasing survival rates. Further, in accordance with aspects of the present system, the present system may perform self-diagnostics and prognostics to ensure safe and reliable operation. To that end, the present system includes one or more internal sensors and/or applications to perform a diagnosis and prognosis and displays resultant diagnostic and prognostic data.

While only certain features of the present invention have been illustrated and described herein, many modifications and changes will occur to those skilled in the art. It is, therefore, to be understood that the appended claims are intended to cover all such modifications and changes as fall within the true spirit of the invention.

1. A health information communications system, comprising:
one or more medical sensors that provide one or more data types of health information;
a patient communications device communicatively coupled to a communications network and to at least one of the medical sensors, said patient communications device having a patient quality of service (QoS) manager, wherein the patient QoS manager dynamically specifies a set of data quality management parameters for transporting at least some of the health information and modifies said some of the health information into value factored health information; and
a specialist communications device communicatively coupled to the patient communication device over the communications network, said specialist communications device having a specialist quality of service (QoS) manager, wherein the specialist QoS manager is configured to provide measured channel characteristics to the patient communications device;
wherein the data quality management parameters of the patient communications device are based at least in part on the measured channel characteristics of the specialist communications device.

2. The system of claim 1, wherein the specialist communications device receives and processes at least some of the value factored health information.

3. The system of claim 2, wherein the specialist communications device is configured to process the value factored health information by at least one of decompressing, decoding, decryption, and deinterleaving.

4. The system of claim 1, wherein the patient communications device is configured to process the value factored health information by at least one of compressing, encoding, encryption, and interleaving.

5. The The system of claim 1, wherein the data quality management parameters are based on at least one of measured channel characteristics, the one or more data types, type of medical examination, data request from the specialist communications device, user requests, user preferences, application settings, location, or combinations thereof.

6. The system of claim 1, wherein the measured channel characteristics comprises bit rate, latency, jitter, packet loss, data errors, and combinations thereof.

7. The system of claim 1, further comprising a patient link monitor and a specialist link monitor, wherein each link monitor is configured to provide the measured channel characteristics.

8. The system of claim 8, wherein at least one of the patient link monitor and the specialist link monitor are configured to independently provide the measured channel characteristics.

9. The system of claim 8, wherein the patient link monitor uses at least one of a desired frequency and a dynamically varying measurement frequency for the measured channel characteristics

10. The system of claim 1, further comprising at least one of a transceiver, a location-determining device, a display device, an authentication unit, an encryption unit, a storage device, an audio input-output device and a video input-output device.

11. The system of claim 11, wherein the location-determining device determines a geographical location of the one or more medical sensors.

12. The system of claim 1, wherein the QoS manager customizes the value factored health information corresponding to each data type for exporting to an Electronic Medical Records (EMR) system.

13. The system of claim 1, wherein the data types comprise audio data, video data, image data, geographical location of the medical sensors, diagnostic data, communication data, or combinations thereof.

14. The system of claim 1, wherein the medical sensors comprise an MRI system, a CT system, an ultrasound system, blood pressure monitor, an X-ray, a video device, image device, an audio device, a commutations system, or combinations thereof.

15. The system of claim 1, wherein patient QoS manager enables dynamic control of the medical sensors.

16. The system of claim 1, wherein at least one of the patient communication device and specialist communication device are implemented in a network edge device, a mobile computing system, a desktop computer, a router, a communications server, or combinations thereof.

17. The system of claim 1, wherein the communications network is configured for at least one of wireless local area networks (WLAN), wide area networks (WAN) such as Worldwide Interoperability for Microwave Access (WiMax) networks, satellite networks, cellular networks, sensor networks, ad hoc networks and short-range networks.

18. A method for communicating health information, comprising:
measuring one or more channel characteristics between a patient communications device and a specialist communications device, said channel characteristics corresponding to one or more communication channels in the communications network;
receiving medical information from one or more sensors communicatively coupled to the patient communications device;
dynamically specifying a set of quality of service (QoS) parameters for at least some of the medical information based in part on the channel characteristics;
processing at least some of the medical information based on the set of quality of service (QoS) parameters into value factored medical information;
transporting at least some of the value factored medical information from the patient communications device over the communication channels; and
receiving at least some of the value factored medical information at the specialist unit over the communications channel.

19. The method of claim 19, further comprising determining a geographical location of the one or more health monitoring devices using a location-determining device.

20. The method of claim 19, further comprising authenticating, securing and authorizing access to the value factored medical information.

21. The method of claim 19, further comprising storing the received information from the sensors for analysis, billing, or a combination thereof.

22. The method of claim 19, wherein routing the medical information comprises combining the information corresponding to two or more data types into simultaneously transmitted message stream or multiplexed message stream.

23. The method of claim 19, wherein receiving the medical information including one or more data types comprises receiving audio data, video data, image data, geographical location of the patient communications device, geographical location of the specialist communications device, geographical location of the sensors, diagnostic data from the sensors, or combinations thereof.

24. The method of claim 19, wherein dynamically specifying the set of parameters for each data type comprises identifying the set of parameters for each data type based on a nature of communication, desired bandwidth utilization, desired quality of the remotely received or transmitted information, desired reliability of the remotely received or transmitted information, desired connection management, desired compression rules, a desired maximum tolerable packet loss rate, desired latency, desired communication handoffs, a desired number of retries, a desired range of packet sizes, desired error correction, or combinations thereof.

25. A health information communications unit, comprising:
a processing unit;
a memory section coupled to the processing unit;
one or more medical sensors communicatively coupled to the processing unit, said medical sensors providing health information of one or more data types;
a patient quality of service (QoS) manager operating on the processing unit and configured to process at least some of the health information as value factored health information and transport at least some of said value factored health information over a communications network, wherein at least some of the value factored health information is configured for said transport based on measured channel characteristics of the communications network; and
a specialist QoS manager interfacing with the patient QoS manager over the communications network, said specialist unit configured to receive and process at least some of the value factored health information.

26. The health information communications unit according to claim 26, wherein wherein at least some of the value factored health information is configured for said transport based on specialist requests and medical examination protocol.
